(19) United States
(12) Patent Application Publication
(10) Pub. No.: US 2013/0342302 A1
(43) Pub. Date: Dec. 26, 2013

(54) COIL BODIES HAVING A CERAMIC CORE

(71) Applicants: Alexander Dohn, Memmelsdorf (DE); Roland Leneis, Marktredwitz (DE); Alfred Thimm, Wunsiedel (DE)

(72) Inventors: Alexander Dohn, Memmelsdorf (DE); Roland Leneis, Marktredwitz (DE); Alfred Thimm, Wunsiedel (DE)

(73) Assignee: CERAM TEC GMBH, Plochingen (DE)

(21) Appl. No.: 14/002,417

(22) PCT Filed: Mar. 12, 2012
(86) PCT No.: PCT/EP2012/054274

§ 371 Date: Sep. 11, 2013

(30) Foreign Application Priority Data
Mar. 11, 2011 (DE) 10 2011 005 447.2

(51) Int. Cl. H01F 3/08; H01F 41/04

(52) U.S. Cl. CPC H01F 3/08; H01F 41/04
USPC 336/221; 427/116

(57) ABSTRACT

Coil bodies having a ceramic core.

Subject matter of the present invention are coil bodies (chokes, frequency filters) having a ceramic core.

Miniaturized coil bodies (chokes, frequency filters) having a ceramic core from a ferromagnetic or diamagnetic material such as Al₂O₃ are well known in high-frequency technology and are widely used. The cores are mostly produced by dry pressing and exhibit a horseshoe-shaped structure with square or rounded edges, are metallized at their ends and carry windings made, e.g., from copper strips or copper wire. Known sizes are 1206, 0805, 0402. They are also available in a bone shape.

Coil bodies having a ceramic core from ferromagnetic or diamagnetic material such as Al₂O₃ have difficulties at maximum frequency to dissipate the resulting heat. Al₂O₃ has a thermal conductivity of about 28 W/mK.

It is therefore an object of the present invention to provide coil bodies having a ceramic core which do not have the disadvantages of the prior art.

The object is achieved by means of the characterizing features of the first claim. Advantageous configurations of the invention are characterized in the sub-claims.

It was surprisingly found that coil bodies having a ceramic core from a highly thermally conductive and electrically insulating material such as diamagnetic AlN, preferably AlN-4%Y2O3, are better at maximum frequency at dissipating the resulting heat. As a result, electrical resistances can be kept low and the Q value can be kept high. The AlN materials used according to the invention achieve a thermal conductivity of over 170 W/mK. The base body can be produced by dry pressing suitable granulate. In a suitable organic composition from waxes and binders, this granulate contains a spray granulate from AlN that has a content of usually preferably 2-6% of sintering aids such as Y₂O₃ or other rare earth compounds, optionally also with CaO, MgO. (This range can principally range from approximately 0.5% to approximately 10%).

The base body that is pressed into the desired shape is sintered at temperatures that are typical for AlN materials; in the case of AlN—Y₂O₃ preferably in a nitrogen atmosphere at 1700° C. Then, a firmly adhering metallized coating is applied onto the ceramic.

Metallization serves for fixing the coil wire and for soldering on the circuit board, and can be carried out, e.g.,
a) with wolfram (glass), burned-in in a deoxidizing moist atmosphere at approximately 1250° C. solderable with electroless nickel,
b) with molybdenum-manganese+electroless nickel, burned-in in moist atmosphere under N₂ at approximately 1250° C., as in a),
c) with solderable silver,
d) with silver-palladium or silver-palladium-platinum or silver-platinum or platinum, but also
e) with copper.

In addition to the metal powder, the variants a) to d) usually also require grass materials that are specifically suitable for AlN, thus react slowly or do not react at all with AlN to form nitrogen. In most cases they are produced on the basis of ZnO.

This metallized coating is burned in at 850° C. in an oxidizing atmosphere.

Suitable methods tor metallization are dipping, screen printing or spraying (similar to an “ink jet” operation). Suitable methods for metallization are described, for example, in DE 198 574 B4.

In order to be able to produce the contact surfaces for solder joints on the molded bodies according to the invention; the molded bodies according to the invention are metallized on the surface regions provided for this. If subsequently, the molded body has been processed according to its intended purpose of use, the molded body is soldered with its contact surfaces onto a circuit board, or connections are soldered onto the contact surfaces.

Metallizing the contact surfaces takes place in a manner known per se by applying a metallization paste on the components onto the surface regions provided for this and by a subsequent heat treatment. The metallization paste is applied by rolling, screen printing or pad printing. These application methods are known, for example, from “Mo—Mn Metallization on AlN Substrate”, Ceramic Transactions, 15/1990 pages 365-374. For example, in the case of U-shaped ceramic coil bodies with particularly small dimensions of the winding body of approximately 6 mm in length, 4 mm in width and 3 mm in height, the legs have a length of approximately 0.6 mm at a width of approximately 1.2 mm. The surface to be metallized in each case on the front sides of the U-legs is therefore approximately 3.6 mm². With the known printing methods, the leg surfaces adjoining the front sides are wetted with the soldering paste only to a very limited extent.

In the case of soldered joints on predefined contact surfaces with such small dimensions, problems with regard to the adhesive strength can occur.

The most important parameters of a soldered joint are the composition of the ceramic material, the metallization paste and the solder, as well as the required adhesive strength which is substantially influenced by the size of the contact surface. In the known application methods for the metallization paste, a multiplicity of molded bodies is aligned such that all surfaces to be printed are aligned in the same direction. These end faces of the molded bodies are then printed with the metallization paste. The surfaces adjoining the printed end face are usually wetted up to an extent of approximately 0.06 mm by metallization paste flowing over the edge. In contrast to this, the metallization method described here, in addition to metallizing the respective end faces, enables also metallizing the surfaces adjacent thereto, in particular the leg surfaces, to any desired extent by dipping the molded bodies into the metallization paste.

In particular for components having legs that face away from the molded body and the end faces of which are to be metallized so as to produce contact surfaces, the dipping depth of the legs can be up to 90% of the leg length. Preferred is a region with a dipping depth of up to 60% of the leg length. The dipping depth is selected in particular in dependence on the size of the molded bodies and therefore in dependence on the leg length. The smaller the leg length, the greater the dipping depth in relation to the leg length can be so as to thereby obtain a metallized surface as large as possible. At a leg length of, for example, 0.6 mm, and a dipping depth of 60% of the leg length, the metallized leg length would be approximately 0.36 mm.

By increasing the metallized surface, the adhesive strength of the metallized coating and therefore also of a soldered joint can be increased accordingly. By increasing the metallized surface by at least 50%, an adhesive strength can be achieved that is more than doubled. Another advantage over the known method for applying the metallization paste is the simpler and faster process flow of the method and, as a result of this, its higher efficiency.

For the dipping process, the molded bodies are all held in the same alignment in such a manner such that the surface regions to be metallized face downward, and the end faces, onto which the connections are to be established, are all arranged at the same height.

According to this method, there are two possibilities of providing she metallization paste for the dipping process. On the one hand, the metallization paste can be provided in a tray. This requires that with increasing removal of the metallization paste due to the dipping processes, each dipping process has to be adapted to the failing level of metallization paste, or the filling level of the metallization paste in the tray has to be set to a constant level.

As an alternative, the metallization paste can be applied onto a flat, horizontally arranged surface in a predetermined layer thickness. For this, the metallization paste can be spread on the surface by means of a squeegee in such a manner that the dipping depth required for the dipping process is available. The molded bodies are then dipped with their surfaces to be metallized into the metallizing paste. Dipping can be carried out until said surfaces rest on the surface that carries the metallization paste. In this manner, a constantly uniform metallization is achieved. However, the viscosity of the metallization paste has to be set such that that after lifting off, the contact surfaces are wetted with the metallization paste in the required layer thickness. After each dipping process, the metallization paste is spread again in the predetermined thickness over the surface. Prior to this, the metallization paste of the previous dipping process can be removed completely from the surface. With this method, in contrast to the previous dipping method, no fluctuating level of the metallization paste in a tray is to be taken into account.

Viscosity and therefore spreading the metallization paste has a significant influence on the result of the metallization. It is therefore of advantage if during dipping the surface regions of the molded bodies to be metallized, the surface of the metallization paste does not bulge due to the displacement caused, for example, by the immersing legs of coil bodies. In this manner it is avoided that the metallization paste wets a region that must not be metallized, for example, that region of the coil bodies that carries the winding. If, for example, terpineol is used for pasting, waving of the paste surface occurs when dipping a molded body due to the slow dispersion of the latter. A high viscosity of approximately 160000 to 250000 mPa·s has proved to be advantageous. For example, a metallization paste that contains metal powder and glass frit in a solution from (2-butoxyethyl)-acetate has such a viscosity. Because of its good flow properties, a very high filling degree of over 85% of solids in the metallization paste is achieved with (2-butoxyethyl)-acetate. Metals such as wolfram, molybdenum or silver-palladium alloys are particularly suitable for metallization.

The residence time in the metallization paste of surface regions of the molded bodies to be metallized can advantageously be adapted to the dipping depth, the viscosity and the dipping speed, and is approximately 0.2 to 2 seconds.

In order to avoid drop formation of the metallization paste on the contact surfaces, in particular on the end faces on which laser the connection is established, it is possible in a further advantageous configuration to allow excess metallization paste to drain onto a surface provided for this purpose, for example, onto a drip plate. For this, the molded bodies are temporarily placed with their end faces covered with the metallization paste onto a flat surface. When lifting off from this surface, the excess metallization paste remains thereon so that no drops form.

This flat surface as a drip plate can also be structured. The structured pattern can consist, for example, of spaced narrow parallel grooves or notches which also can form a grid into which the excess metallization paste flows off. The grooves or notches can be inclined coward one side of the drip plate so that the excess metallization paste can drain automatically from she structured pattern. If the drip plate is arranged higher than the dipping tray containing the metallization paste, the grooves or notches can be inclined such chat the excess metallization paste flows back into the tray.

The flat surface can also be a screen or a wire mesh arranged above a surface. When placing the end faces of the molded bodies onto the screen, the excess metallization paste drips through the screen and onto this surface. If this surface is inclined toward the dipping tray containing the metallization paste, here too, the excess metallization paste flows automatically back into the tray.

As a residence time on the surface for draining the excess metallization paste, depending on the degree of metallization and the viscosity of the metallization paste, a time of from 0.2 to 2 seconds has proved to be advantageous.

In order to be able to carry out continuous metallization of the molded bodies, it is advantageous if the surface onto which the excess metallization paste drips is subsequently cleaned immediately. The excess metallization paste, for example, can be wiped off with a squeegee, or the surface is replaced by another available surface that is clean. While the excess metallization paste of a previous dipping process drips onto this surface, the previously used surface can be cleaned.

The dipping process and the subsequent discharging of excess metallization paste can be advantageously accelerated in that between applying the metallization paste and discharging the excess metallization paste, the unit with the molded bodies held, therein, and the tray or surface containing the metallization paste and also the surface for receiving the excess metallization paste are moved relative to each other. In this case, the tray containing the metallization paste or the surface containing the metallization paste spread thereon as well as the surface for discharging the excess metallization paste are arranged next to each other. The unit with the molded bodies to be metallized either stands still and the tray or surface containing the metallization paste and the surface for discharging the excess metallization paste are moved back and forth below the unit, or the tray or surface containing the metallization paste and the surface for discharging the excess metallization paste remain stationary and the unit with, the molded bodies held therein is moved back and forth between the metallization paste and the surface for discharging the excess metallization paste.

The method can also be used for coil bodies or resistors as follows. While being inserted vertically in holes of a belt, first the one said face and, after reclamping the belt, the second end face can be metallized by dipping into the metallization paste. The belt, with the molded bodies is clamped horizontally in a suitable holding device at the unit for handling the molded bodies.

The process flow of the metallization method is explained in more detail by means of the following exemplary embodiments.

In the figures:

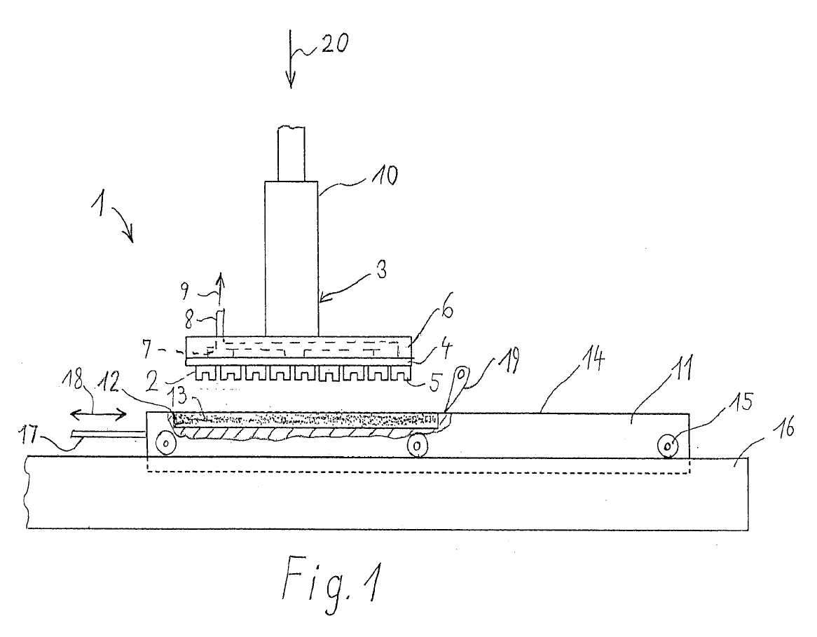

FIG. 1 shows a device for metallizing surface regions of ceramic molded bodies having small dimensions, wherein the unit for handling the molded bodies is in the starting position above a movable table with a tray filled with metallization paste,

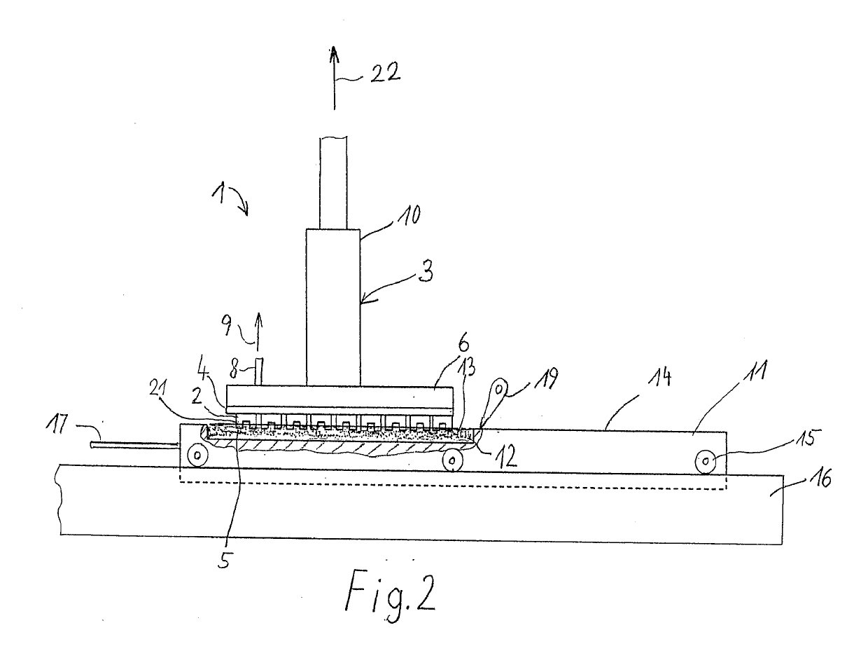

FIG. 2 shows the molded bodies during dipping into the metallization paste,

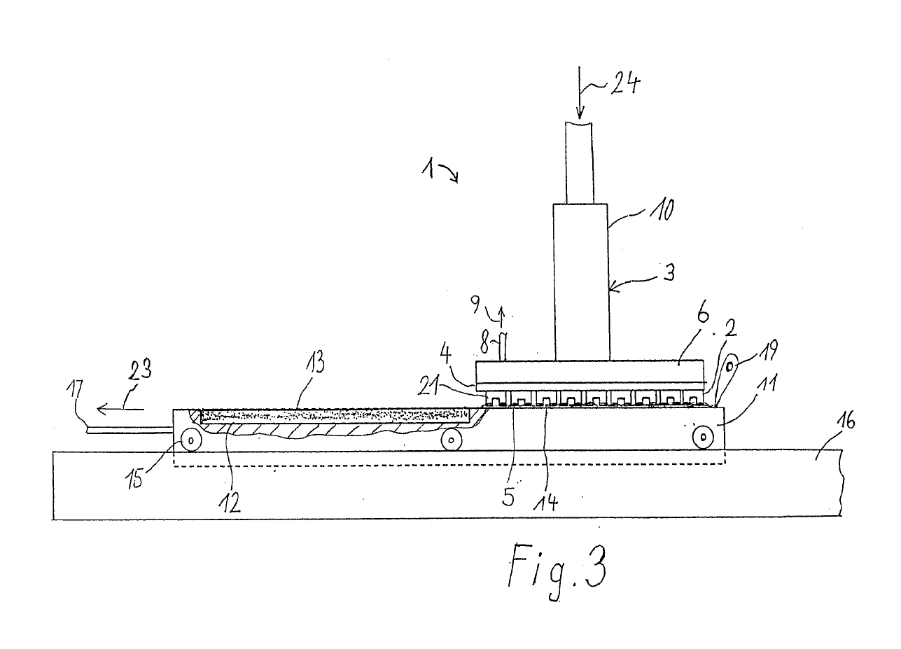

FIG. 3 snows the molded bodies placed onto a drip plate for removing excess metallization paste,

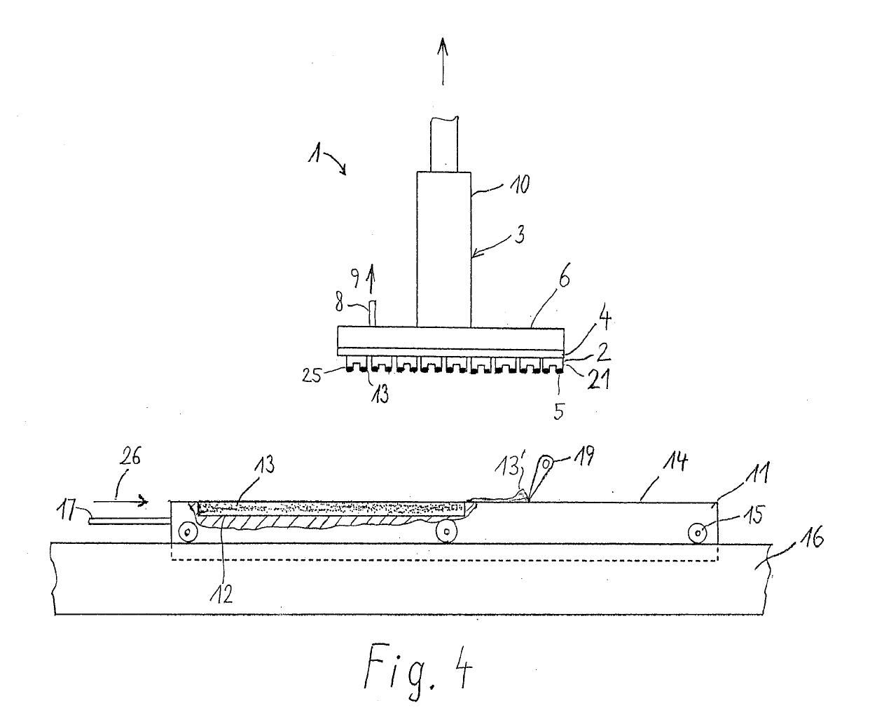

FIG. 4 shows the metallized molded bodies that are provided by the unit so as to be transferred for their further handling, and the cleaning of the drip plate,

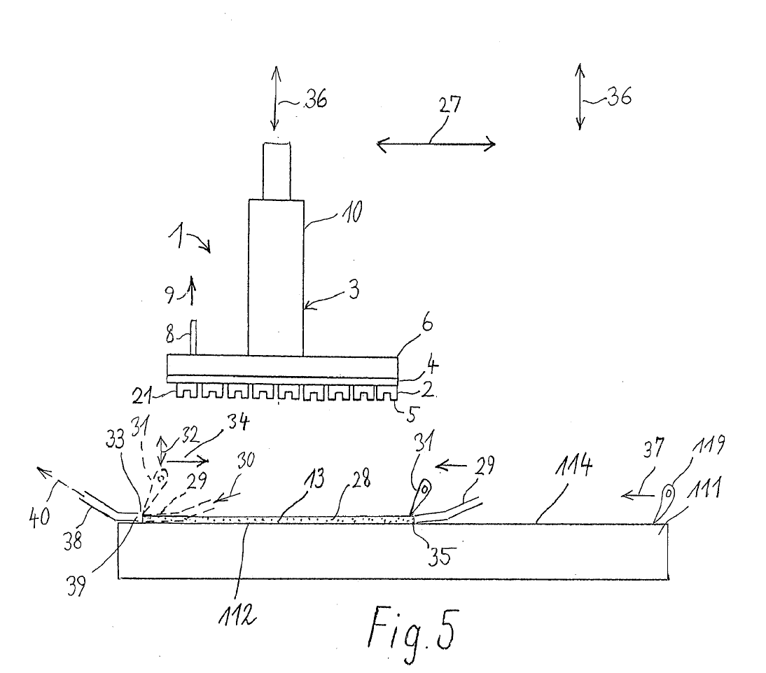

FIG. 5 shows a further device, wherein a movable unit for handling the molded bodies is in its starting position above a surface onto which a layer with metallization paste is applied,

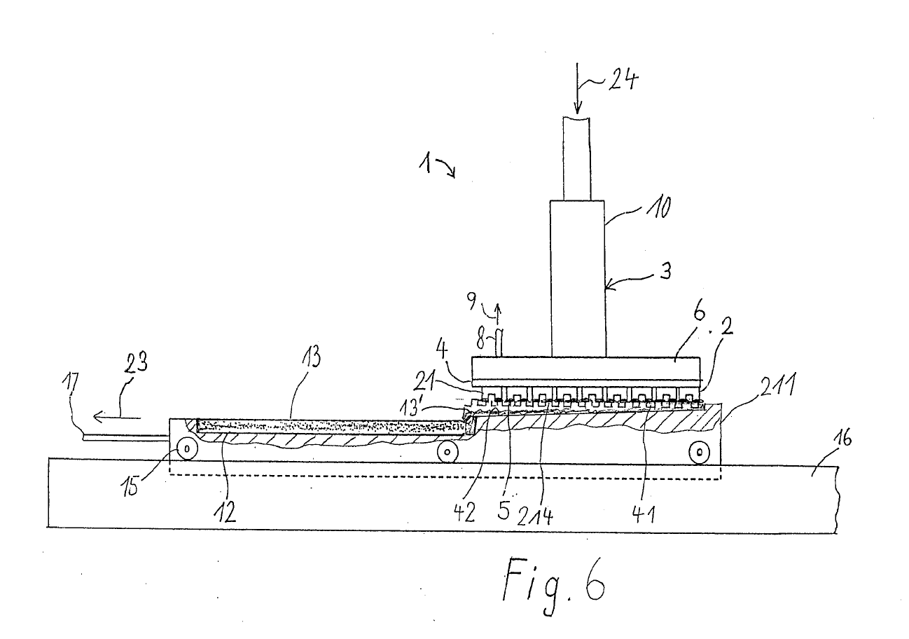

FIG. 6 shows a table with a structured surface as a drip plate, and

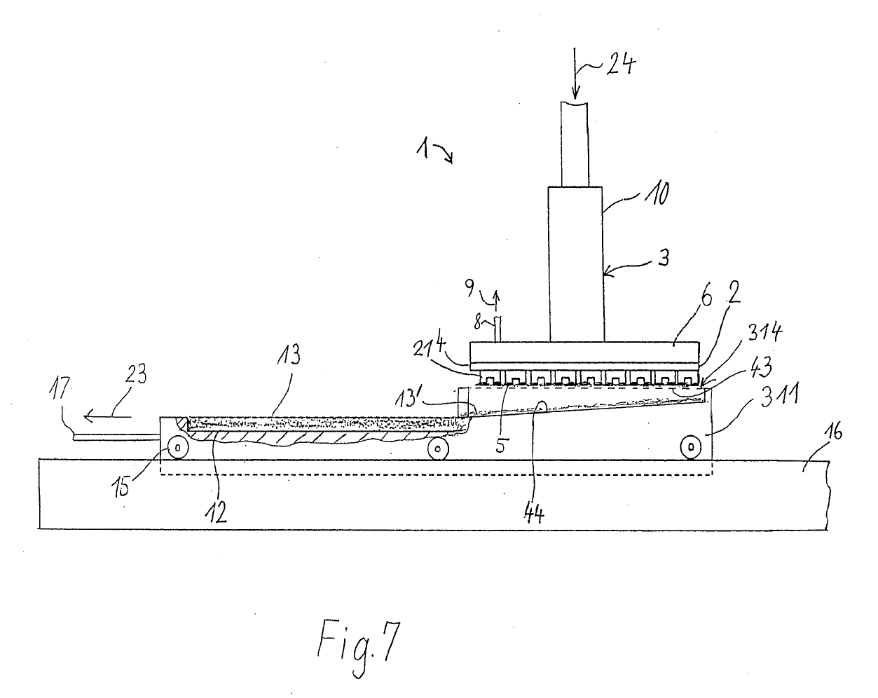

FIG. 7 shows a table with a screen as a drip plate.

In FIG. 1, a schematic illustration of a device for metallizing surface regions of ceramic molded bodies having small dimensions is designated by 1. In order to be received by a unit 3 for handling ceramic molded bodies 2, the ceramic molded bodies 2 are temporarily fixed on a holding plate 4. In the present exemplary embodiment, the ceramic molded bodies are U-shaped coil bodies. These coil bodies have first been aligned by means of a vibrating plate and have then been received by a heated flat plate, for example from ceramics or metal, that is covered with a thermoplastic, temporarily active adhesive. By pressing with a counter plate, the coil bodies have been fixed on the holding plate 4. In the process of this, they have been aligned such that the surface regions to be metallized, thus the end faces 5 onto which the connections are to be soldered on, are arranged at the same height. The holding plate 4 with the coil bodies 2 temporarily glued thereon has then been received by the stamping plate 6 of the unit 3. In the present exemplary embodiment, holding takes place by means of negative pressure via suction nozzles 7 which are arranged in the surface of the stamping plate and, as marked by a dashed line, are distributed above the holding plate 4. A connection 8 leads to a negative pressure source, which is not illustrated here, in which, symbolized by the arrow 9, the negative pressure required for fixing the holding plate is produced.

The stamping plate 6 is attached to a telescopic cylinder 10, The design features required for the function of the unit 3 for handling the molded bodies are known from the prior art and are therefore not illustrated and explained in detail here.

In FIG. 1, the unit 3 for handling the molded bodies 2 is in its starting position above a table 11. On the left side, this table 11 carries a tray 12 that is filled with metallization paste 13. Next to this, on the right side, there is a flat, horizontally arranged surface 14 that serves as a drip plate for removing excess metallization paste on the molded bodies 2.

In the present exemplary embodiment, the table 11 has roils 15 by means of which the table is mounted on guide rails 16, of which only the front guide rail is shown here. On these guide rails 16, as indicated by the double arrow 18, the table 11 can be moved back and forth below the unit 3 for handling she molded bodies 2 by means of a drive which is not shown here and to which the connecting rod 17 leads. The table 11 can be moved from the illustrated position, in which the tray 12 containing the metallization paste 13 is situated below the unit 3 for handling the molded bodies 2, into a position as it is illustrated in FIG. 3. Then, the drip plate 14 is beneath the unit 3 for handling the molded bodies 2. Furthermore, a squeegee 19 is illustrated by means of which tine drip plate 14 is cleaned from the excess metallization paste that has drained from the metallized surfaces of the molded bodies 2.

FIG. 2 illustrates the method step in which the molded bodies 2, which are the coil bodies in the present exemplary embodiment, are dipped with their surface regions to be metallized into the tray 12 containing the metallization paste 13. For this, the stamping plate 6 has been lowered from its starting position illustrated in FIG. 1 in the direction of the arrow 20 (FIG. 1) by means of the telescopic cylinder 10. The dipping depth of the coil bodies can be controlled via the telescopic cylinder 10 in such a manner that not only the end faces 5 are wetted, but also the adjacent surfaces of the U-legs 21 of the coil bodies 2 are wetted by the metallization paste 2 up to a predetermined depth. Due to the high viscosity of the metallization paste of approximately 160000 to 250000 mPa·s, no bulging of the surface of the metallization paste takes place. Thereby it is avoided that the winding space between the legs 21 is wetted by the metallization paste 13, and it is ensured that the actual wetting of the surface corresponds to the predetermined dipping depth. The dipping depth can be up to 90% of the leg length, but it is preferably selected in the range of up to 60%, depending on the size of the molded bodies and the length of the legs.

When the molded bodies 2, after the predetermined residence time, are lifted again out of the metallization paste 13 by means of the unit 3, as indicated by the arrow 22, drops of the metallization paste can form on the end faces 5 of the mold bodies 2. Such drops would result in an uneven application of the metallization paste. For this reason it is provided according to the method that the excess metallization paste is removed from the surfaces to be metallized. For this, the drip plate 14 is used that is connected to the tray 12 containing the metallization paste 13.

After the molded bodies 2 attached to the stamping place 6 have been lifted out of the tray 12, as indicated by the arrow 12, the table 11 is moved in the direction of the arrow 23 until the drip plate 14 is beneath the stamping plate 6. Then, the stamping plate 6 with the metallized molded bodies 2 is lowered in the direction of the arrow 24 by means of the telescopic cylinder 10 until the end faces, here the end faces 5 of the legs 21 of the coil bodies 2, touch or almost touch the surface of the drip plate 14, as illustrated in FIG. 3. When an end face 5 abuts against the surface of the drip plate 14, it has to be ensured that the metallization paste is not completely pushed away by the end face. How close the end face 5 may come to the surface of the drip plate 14 depends on the viscosity of the metallization paste 13 and the desired layer thickness of the metallized coating on the end face 5. The degree of draining can also be controlled via the residence time, which can range between 0.2 and 2 seconds.

in FIG. 4, the method step is illustrated in which the molded bodies 2 are lifted off from the drip plate 14. The U-shaped legs 21 of the coil bodies 2 are covered with the metallizing paste 13 not only on the end face 3, but also over a length 25 that corresponds to the dipping depth. The coil bodies metallized in this manner can be fed to the subsequent heat treatment of the metallization paste after they have been detached from the holding plate 4.

Furthermore, it is illustrated in FIG. 4 how the table 11 is retracted into its starting position illustrated in FIG. 1, as indicated with the arrow 26. While the table 11 is retracted on the guide rails 16 into its starting position, the excess metallization paste 13′ drained from the coil bodies 2 is wiped off from the drip plate 14 by means of a squeegee 19 and is pushed back into the tray 12. Thereby, the surface or the drip plate 14 is cleaned and is prepared for a new batch of metallized molded bodies to be placed thereon.

FIG. 5 illustrates a further exemplary embodiment for a method for metallization of surface regions of ceramic molded bodies. Of the device 1, she unit 3 for handling the molded bodies 2 to be metallized corresponds to the previous exemplary embodiment. Also, as in the previous exemplary embodiment, the molded bodies 2 to be metallized are U-shaped coil bodies.

The metallization method differs from that of the previous exemplary embodiment in that the table 111 is arranged stationarily, while the unit 3 for handling the coil bodies 2 can be moved back and forth between a region 112, onto which the metallization paste 13 is applied, and a region 114 that forms the drip plate, as indicated by the double arrow 27. In contrast to the previous exemplary embodiment, the metallization paste 13 is applied in the region 112, which is the metallization region, with a predetermined layer thickness onto the table 111. Applying is carried out in that metallization paste 13 from a reservoir, which is not shown here, is applied in the region 112 onto the table 111 by means of a feeding unit 29, as indicated by the arrow 30. The thickness of the layer 26 to be applied is adjusted by means of a squeegee 31. For this purpose, the spacing between the squeegee 31 and the table 111 is adjustable, as indicated by the double arrow 32.

From their position 33, which is marked by a dashed line, the feeding unit 29 and the squeegee 31 are moved in the direction of the arrow 34 up to the illustrated position 35. In the process of this, the metallization paste 13 is applied in the predetermined layer thickness 28 onto the region 112 of the table 111.

After applying the metallization paste 13, the unit 3 with the coil bodies 2 is lowered until the legs are dipped with the required dipping depth into the metallization paste 13. As explained above, dipping can be carried out until the end faces rest on the table 111. Lifting and lowering of the unit 3 is indicated by the double arrow 36. After the metallization, the coil bodies 2 are lifted and the unit 3 is moved over the drip plate 114.

The squeegee 31 and the feeding 29 can now already be moved back into their starting position 33. For this, they are lifted until they are no longer dipped in the metallization paste 13.

After the excess metallization paste 13′ has drained from the coil bodies 2 by placing them onto the drip plate 114, the stamping plate 6 is lifted high enough that the holding plate 4 with the coil bodies 2 can be removed, and the metallized coil bodies, after detaching them from the holding plate 4, can be transferred to the further provided heat treatment. Lifting and lowering in the region of the drip plate 114 is indicated by the double arrow 36.

In order to prepare a new dipping process, both the drip plate 114 and the region 112 have to be cleaned from the metallization paste. For this purpose, a squeegee 119 specifically provided for cleaning the table 111 is moved in the direction of the arrow 37 up into the position 33. At the same time, the metallization paste 13′ that is no longer needed is sucked off by a tube 38 that has a nozzle 33 that covers the width or the region 112, as indicated by the arrow 40. This extracted metallization paste can then be fed again, which is not illustrated here, to the feeding unit 29 and can be used again for reapplying metallization paste in the region 112 of the table 111.

Another exemplary embodiment in FIG. 6 shows a fiat surface 214 on a table 211, which surface is structured and is situated slightly higher than the surface of the metallization paste 13 in the tray 12. The structure consists of spaced narrow parallel grooves or notches 41. The grooves or notches can also extend in a grid-shaped manner. The grooves or notches 42 which face toward the dipping tray 12 containing the metallization paste 13 are inclined such that the excess metallization paste can automatically flow back into the tray 12.

FIG. 7 illustrates an exemplary embodiment with a table 311, the drain surface of which consists of a screen-shaped wire mesh 314. When placing the end faces 5 of the molded bodies 2 onto this drain surface 314, the excess metallization paste 13′ drips onto the surface 44 therebelow. The latter can be inclined such that the excess metallization paste 13′ automatically flows back into the tray 12.

The coil bodies according to the invention are characterized by better heat dissipation, lower resistance in the wire, a better Q value and by less heat loss than the coil, bodies known from the prior art, which are made from ferromagnetic or diamagnetic material such as Al₂O₃.

The present invention therefore relates to a:
coil body having a ceramic core from highly thermally conductive, electrically insulating material.
wherein
   • the ceramic core consist, of a highly thermally conductive, electrically insulating material with a thermal conductivity >28 W/mK;
   • the ceramic core contains AlN;
   • the ceramic core contains AlN and up 10% of sintering aids, preferably sintering aids in quantities of from 0.5 to 10%, particularly preferred in quantities of from 2 to 6%;
   • the ceramic core contains AlN and as a sintering aid Y₂O₃, other rare earth compounds, CaO and/or MgO;
   • the ceramic core contains AlN-4%Y₂O₃,

The enumerations designated by • represent optional, preferred configurations of the coil body according to the invention.

The present invention further relates to a:
method for producing the above-mentioned coil bodies, in which the base body of the coil body is produced from a suitable granulate in a suitable organic composition by means of a suitable pressing method, the base body pressed into the desired shape is sintered, and a firmly adhering metallized coating is applied onto the ceramic.
   wherein
∘ as a granulate, a spray granulate is used;
∘ the organic composition contains waxes and binders;
∘ as a pressing method, the dry pressing method is used;
∘ the spray granulate contains a proportion of sintering aids;
∘ as a sintering aid, Y₂O₃, other rare earth compounds, CaO and/or MgO are used;
∘ the sintering aids are used in quantities of from 0.5 to 10%, preferably in quantities of from 2 to 6%;
∘ the base body pressed into the desired shape is sintered in an inert gas atmosphere;
∘ as an inert gas, nitrogen is used;
∘ the coil body is sintered at 1700° C;
∘ during the metallization of the coil bodies, a number of coil bodies (2) having the same shape are held in identical alignment by means of a unit (3) in such a. manner that the surface regions (5, 21) to be metallized face downward thereby forming the end faces (5) of the molded bodies (2), that the end faces pig of all molded bodies (2) are arranged at the same height, that the molded bodies (2) are dipped far enough into the metallization paste (13) by means of the unit (3) that the surface regions (5, 21) to be metallized are completely covered by the metallization paste (13), and that subsequently, the molded bodies (2) are subjected to a heat treatment that is adapted to the composition of the metallization paste (13);
∘ the metallization paste (13) is filled into a tray (12);
∘ the metallization paste (13) is applied as a layer (28) with a predetermined thickness onto a horizontally arranged flat surface (112);
∘ for pasting the metallization paste (13, 13′), (2-butoxyethyle)-acetate is used;
∘ the metallization paste (13) has a viscosity of approximately 160000 to 250000 mPa·s;
∘ in the case of molded bodies (2) having legs (21) facing away from the molded body (2), the dipping depth (25) of the legs (21), in dependence on the size of the molded, bodies (2) and the length of the legs (21), is selected to be up to 90%, preferably in a range of up to 60%, of the length of the legs (21);
∘ the residence time in the metallization paste (13) of the surface regions (5, 21) of the molded bodies (2) so be metallized is approximately 0.2 to 2 seconds;
∘ after applying the metallization paste (13) onto the surface regions (5, 21) of the molded bodies (2), the molded bodies (2) are lifted out of the metallization paste (13), that the molded bodies (2) sore temporarily placed with their end faces (5), which covered with metallization paste (13), onto a flat surface (14, 114, 214, 314), and that by placing them onto the surface (14, 114, 214, 314), the excess metallization paste (13′) is removed;
∘ the fiat surface (214) is structured and that the excess metallization paste (13′) flows into the structured pattern (41, 42);
∘ the end faces (5) of the molded bodies (2) are placed onto a screen (314);
∘ the duration of placement on the surface (14, 114, 214, 314) for removing excess metallization paste (13′) is approximately 0.2 to 2 seconds;
∘ after lifting off the molded bodies (2) from the surface (14, 114), the excess metallization paste (13′) is removed from the surface (14, 114);
∘ the excess metallization paste (13′) is wiped off with a squeegee (19, 119);
∘ the excess metallization paste is washed off;
∘ the excess metallization paste (13′) flows off automatically from the surface (214, 314);
∘ between applying the metallization paste (13) and discharging the excess metallization paste (13′), the unit (3) with the molded bodies (2) held therein and the tray (12) or the surface (112) containing the metallization paste (13) as well as the surface (14, 114, 214, 314) for receiving the excess metallization paste (13′) are moved relative to each other.

The enumerations designated by ∘ represent optional, preferred configurations of the method according to the invention for producing the coil bodies according to the invention.

1-32. (canceled)

33. A coil body having a ceramic core from a highly thermally conductive, electrically insulating material.

34. The coil body according to claim 33, wherein the ceramic core consists of a highly thermally conductive, electrically insulating material with a thermal conductivity of >28 W/mK.

35. The coil body according to claim 33, wherein the ceramic core contains aluminum nitride (AlN).

36. The coil body according to claim 33, wherein the ceramic core contains AlN and up 10% of sintering aid.

37. The coil body according to claim 33, wherein, the ceramic core contains AlN and a sintering aid selected from the group consisting of Y₂O₃, another rare earth compound, CaO and MgO.

38. The coil body according to claim 33, wherein the core contains AlN-4%Y₂O₃.

39. A method for producing a coil body according to claim 33, wherein the coil body comprises a base body produced from a suitable granulate in a suitable organic composition by means of a suitable pressing method, the base body pressed into the desired shape is sintered, and a firmly adhering metallized coating is applied onto the ceramic.

40. The method according to claim 39, wherein the granulate is a spray granulate.

41. The method according to 39, wherein the organic composition comprises a wax and a binder.

42. The method according to claim 39, wherein the pressing method is a dry pressing method is used.

43. The method according to claim 40, wherein the spray granulate comprises a sintering aid.

44. The method according to claim 37, wherein the characterized in sintering aid is selected from the group consisting of Y₂O₃, another rare earth compounds, CaO and MgO.

45. The method according to claim 33, wherein the sintering aid is present in a quantity of from 0.5 to 10%.

46. The method according to claim 33, wherein the sintering is conducted in an inert gas atmosphere.

47. The method according to claim 46, wherein the inert gas is nitrogen.

48. The method according to claim 39, wherein the coil body is sintered at 1700° C.

49. The method according to claim 39, wherein during the metallization of the coil bodies, a number of coil bodies having the same shape are held in identical alignment by means of a unit in such a manner that the surface regions to be metallized face downward thereby forming the end faces of the molded bodies;
wherein the end faces of all molded bodies are arranged at the same height;
wherein the molded bodies are dipped far enough into the metallization paste by the unit that the surface regions to be metallized are completely covered by the metallization paste; and
wherein subsequently the molded bodies are subjected to a heat treatment that is adapted to the composition of the metallization paste.

50. The method according to claim 49, wherein the metallization paste is filled into a tray.

51. The method according to claim 49, wherein the metallization paste is applied as a layer with a predetermined thickness onto a horizontally arranged flat surface.

52. The method according to claim 49, wherein the metallization paste is (13, 13′), (2-butoxyethyle)-acetate.

53. The method according to claim 49, wherein, the metallization paste has a viscosity of approximately 160,000 to 250,000 mPa·s.

54. The method according to claim 49, wherein the molded bodies have legs facing away from the molded body; the dipping depth of the legs, in dependence on the size of the molded bodies and the length of the legs, is selected up to 90% of the length of the legs.

55. The method according to claim 49, wherein the residence time in the metallization paste of the surface regions of the molded bodies to be metallized is approximately 0.2 to 2 seconds.

56. The method according to claim 49, wherein after applying the metallization paste onto the surface regions of the molded bodies, the molded bodies are lifted out of the metallization paste;
wherein the molded bodies are temporarily placed with their end faces, which are covered with metallization paste, onto a flat surface; and
wherein by placing them onto the surface excess metallization paste is removed.

57. The method according to claim 56, wherein the flat surface is structured and that the excess metallization paste flows into the structured pattern.

58. The method according to claim 56, wherein the end faces of the molded bodies are placed onto a screen.

59. The method according to claim 56, wherein the duration of placement on the surface for removing the excess metallization paste is approximately 0.2 to 2 seconds.

60. The method according to claim 56, wherein after lifting off the molded bodies from the surface, the excess metallization paste is removed from the surface.

61. The method according to claim 60, wherein the excess metallization paste is removed with a squeegee.

62. The method according to claim 57, wherein excess metallization paste is washed off.

63. The method according to claim 57, wherein the excess metallization paste flows off automatically from the surface.

64. The method according to claim 56, wherein applying the metallization paste and discharging excess metallization paste, the unit with the molded bodies held therein and the tray or the surface containing the metallization paste as well as the surface for receiving the excess metallization paste are moved relative to each other.
